(19) United States
(12) Patent Application Publication
(10) Pub. No.: US 2010/0192806 A1
(43) Pub. Date: Aug. 5, 2010

(54) Method and system for recycling remaining powder of an equipment for generatively manufacturing three-dimensional objects

(75) Inventors: Martin Heugel, Landsberg am Lech (DE); Michael Shellabear, Krailling (DE); Sven Pawliczek, Gilching (DE); Horst Maier, Planegg (DE)

Correspondence Address: EDWARDS ANGELL PALMER & DODGE LLP, P.O. BOX 55874, BOSTON, MA, 02205, US

(73) Assignee: EOS GmbH Electro Optical Systems, Krailling (DE)

(21) Appl. No.: 12/657,426

(22) Filed: Jan. 20, 2010

(30) Foreign Application Priority Data
Jan. 23, 2009 (DE) 10 2009 005 769.2
Jan. 23, 2009 (DE) 20 2009 000 825.8

(51) Int. Cl. C09D 1/00; B05C 11/00

(52) U.S. Cl. 106/286.1; 118/603; 118/712; 118/708

(57) ABSTRACT

The present invention relates to a method and a system for recycling of remaining powder from an equipment for generatively manufacturing three-dimensional objects (3), wherein, in addition to sieving of remaining powder (3a) or mixing the remaining powder (3a) with fresh powder, a further preparing step for modifying a characteristic of the resulting powder is performed.

The present invention relates to a method and a system for recycling remaining powder of an equipment for generatively manufacturing three-dimensional objects.

DE 201 07 262 U1 describes a method and a system for recycling powder for manufacturing three-dimensional objects. The system consists of a building device, which layerwise applies powdery material onto a support or a previously applied layer and solidifies the powdery material by energetic radiation at locations corresponding to the object. Non-solidified remaining powder is directly conveyed from the building device via a conveying line into a sieving device, which is separately provided from the building device and sieves the remaining powder supplied from the building device. The sieved remaining powder is conveyed in a storage container via a further conveying line, and can be used again.

DE 103 42 883 A1 describes a building device for manufacturing three-dimensional objects having integrated suction means and an internal or external sieving device.

Hitherto, integrated tubes and hoses were used in such building devices, wherein the cleaning process thereof is complicated and, thus, causes contaminations by use of different powdery materials.

In particular, a problem occurs with metalliferous powders in that aging of the powdery material by oxidation etc. strongly depends on the grain size. However, recycling of metalliferous powder is commonly used in general. As metalliferous powdery material, any metals and their alloys as well as mixtures with metallic components or with non-metallic components are considered. Besides, pure non-metallic powders such as synthetic powders can also be used.

The powder is subjected to different conditions in the equipment. Around the built object, there are higher temperatures than at the periphery of the building space. Moreover, the powder in a lower portion of the building area is subjected to the high temperature in the building space for a longer time than the powder in the upper portion of the building space. Furthermore, agglomerate are created within the building space, but not in the storage container and in the bleeder container. Moreover, fine particles are generated in the building space by condensation, which are deposited in or on the powder. Furthermore, abrasive wear can be generated from an application blade.

When fresh powder and previously used remaining powder are now subsequently supplied to a storage container, stratification including different characteristics is generated in the storage container. This exerts a negative impact to the building process.

It is the object of the present invention to provide a method and a system for recycling remaining powder from an equipment of generatively manufacturing three-dimensional objects, which enable enhanced quality of the building process and the objects as well as enhanced economic efficiency.

This object is achieved by the method having the features of claim 1 and by the system having the features of claim 12. Advantageous further developments are defined in the dependent claims.

Further features and aims of the invention can be gathered from the description of embodiments on the basis of the enclosed drawings.

In the Figures show:

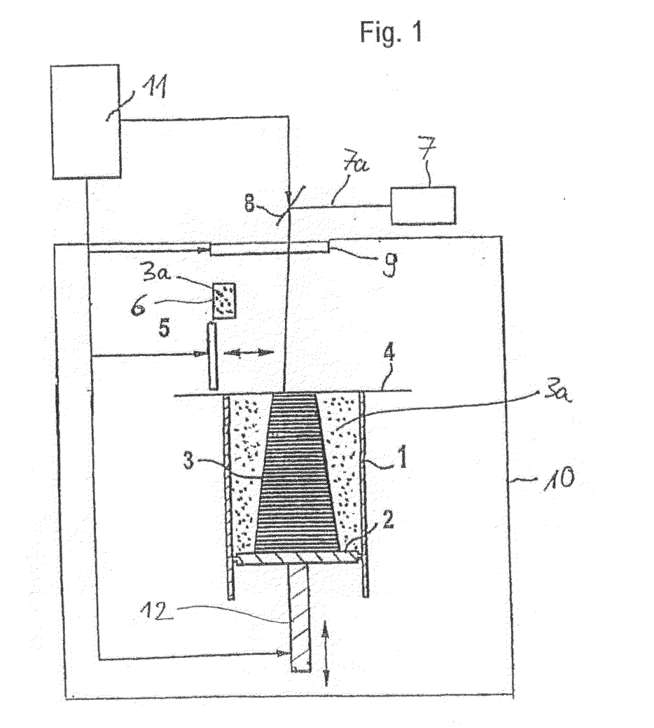

FIG. 1 a schematic view of a building device for manufacturing three-dimensional objects;

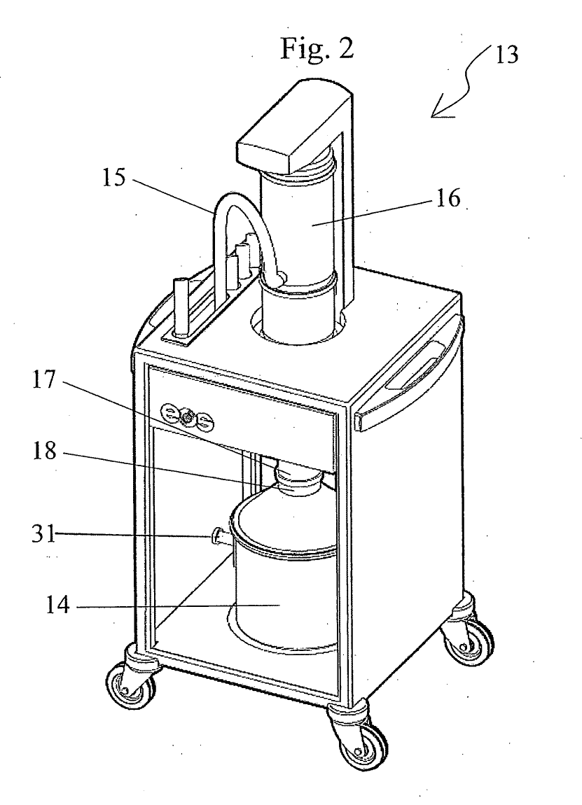

FIG. 2 a suction device according to the invention, which is separately provided from the building device;

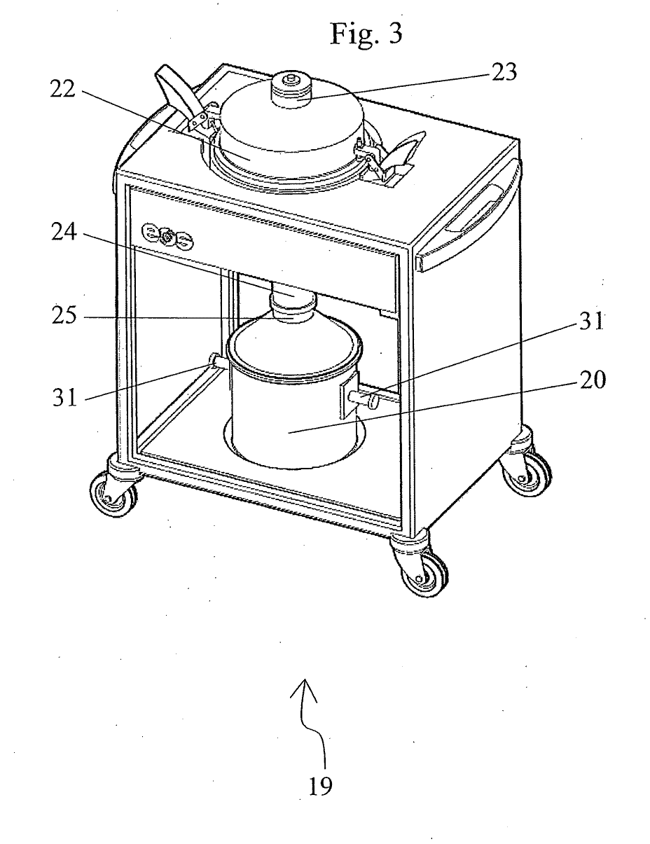

FIG. 3 a sieving device according to the invention, which is separately provided from the building device;

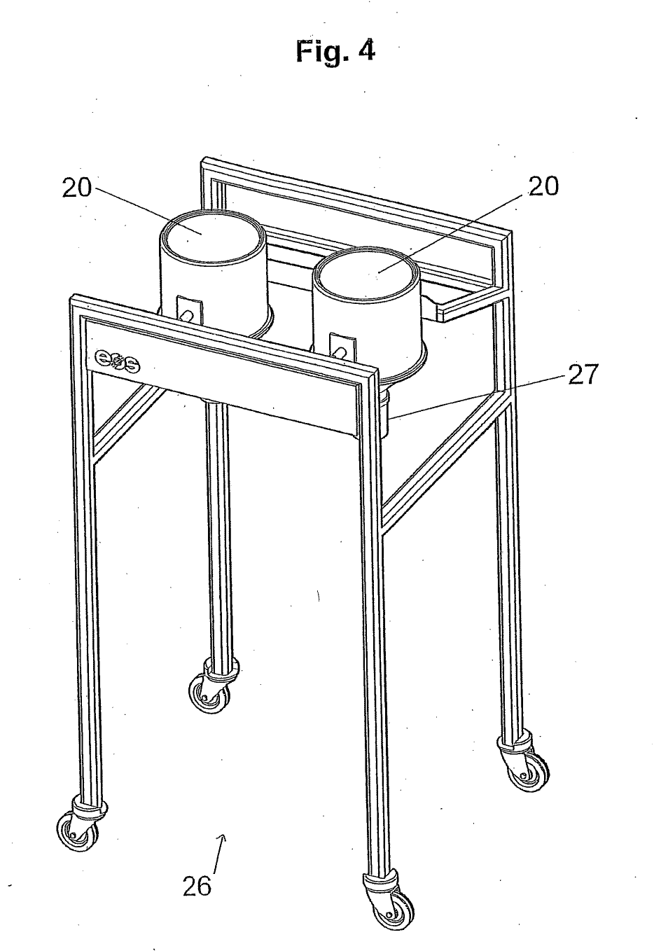

FIG. 4 a supplying device according to the invention, which is separately provided from the building device;

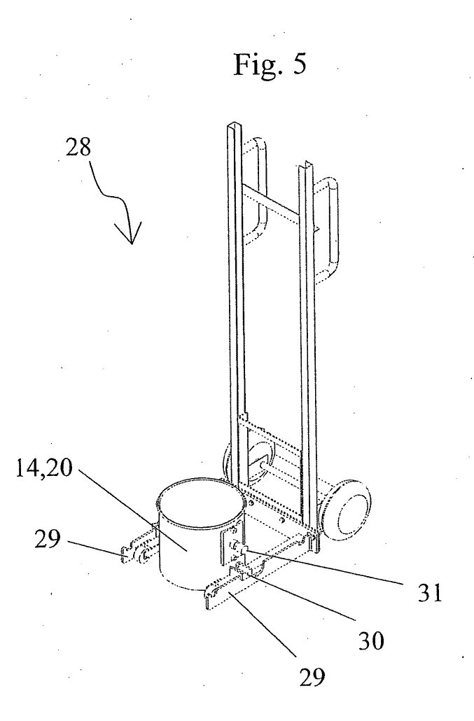

FIG. 5 a transport device according to the invention, which transports a replacement container; and

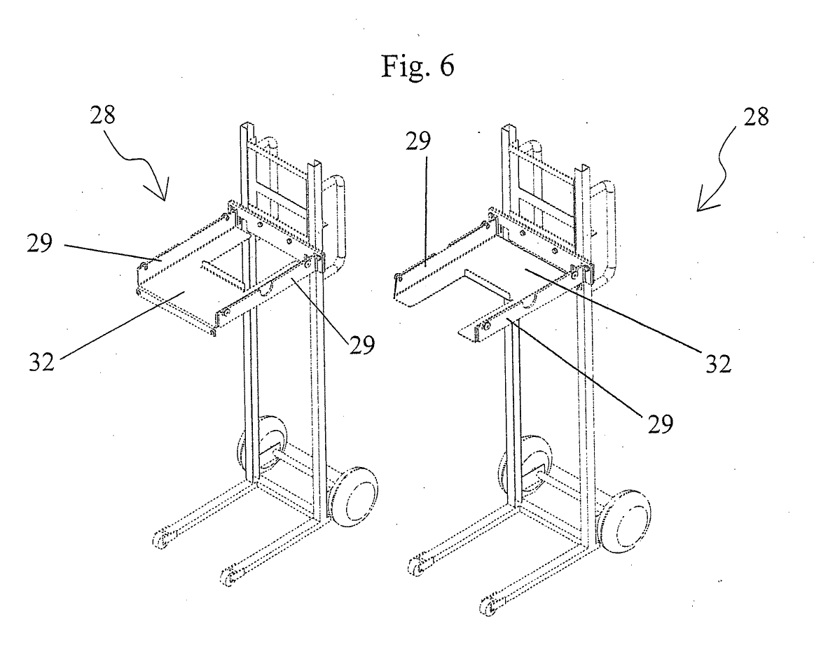

FIG. 6 the transport device according to the invention 30, having an adapter plate for substrate plates and clamping systems.

A method and a system for recycling remaining powder from an equipment for generatively manufacturing three-dimensional objects are described below on the basis of the figures.

FIG. 1 shows a schematic view of a building device for manufacturing a three-dimensional object 3 according to the present invention, which is formed as a laser sintering device in the embodiment.

The laser sintering device comprises a frame 1, which opens on the top and includes therein a platform 2, which is movable in the vertical direction and supports the three-dimensional object 3 to be manufactured. The frame 1 and the platform 2 define a building space inside. The platform 2 is connected to a lifting device 12, by which it is moved in the vertical direction such that the layer of the object 3, which is to be solidified, lies within a working plane 4.

Although not shown in FIG. 1, a metallic substrate plate can be manually placed onto the platform, and it can be fixed or screwed, if applicable. Such substrate plates, especially having the sintered objects 3 thereon, are relatively heavy. Preferably, a zero-point clamping system is used, wherein the substrate plate commonly comprises at least one bolt or pin at the lower side, which has to be lifted from the clamping system before unloading.

Furthermore, an applicator 5 for applying a layer of a powder 3a is provided. As powder 3a, all powders can be used which can be laser-sintered. As metalliferous powdery material, any metal and any alloys thereof as well as mixtures with metallic components or with non-metallic components are considered. Besides, pure non-metallic powders such as synthetic powders can also be used. First, the powder 3a is supplied from a storage container 6. Thereafter, the applicator 5 is moved to a predetermined height in the working plane 4 so that the layer of the powder 3a lies over the lastly solidified layer by a defined height. The building device further comprises a laser 7 generating a laser beam 7a which is focussed to arbitrary locations in the working plane 4 by deflection means 8. Thereby, the laser beam 7a can selectively solidify the powder 3a at locations corresponding to the cross-section of the object 3 to be manufactured in the respective layers.

Reference sign 10 designates a process chamber, in which the frame 1, the platform 2, the lifting device 12 and the applicator 5 can be placed. The inside of the process chamber 10 is accessible by opening a door (not shown). Reference sign 9 designates an opening in the process chamber 10 for introducing the laser beam 7a. Furthermore, a control unit 11 is provided, by which the building device is controlled to perform the building process in a coordinated manner.

During operating of the building device, the platform 2 is moved by the lifting mechanics 12 in a first step, until the upper side thereof lies below the working plane 4 by the thickness of a layer. Thereafter, a first layer of the powder 3a is applied onto the platform 2 and smoothed by the storage container 6 and the applicator 5. Thereafter, the control unit 11 controls the deflection means 8 such that the deflected laser beam 7a selectively strikes on the locations of the layer of the powder 3a, which are to be solidified. Thereby, the powder 3a is solidified and sintered, respectively, at these locations.

In a next step, the platform 2 is lowered by the lifting device 12 by the thickness of the next layer. A second material layer is applied and smoothened by the storage container 6 and the applicator 5, and it is selectively solidified by means of the laser beam 7a. These steps are repeated until the desired object 3 is manufactured.

FIG. 2 shows a suction device 13 which is separately provided from the building device. The suction device 13 is arranged in a mobile creeper and has an accommodation area for the first replacement container 14. The first replacement container 14 is replaceable arranged in the suction device 13. The suction device 13 suctions non-solidified remaining powder 3a via a flexible suction hose 15 from the building device into the first replacement container 14. The flexible suction hose 15 can be provided with different nozzles which are adapted to the geometry of the object 3 or to the material of the remaining powder 3a to be suctioned. The depicted suction device 13 further has a pressurized air port (not shown), by which it is supplied with pressurized air. A pressurized air source is commonly present in the building devices. The suction device 13 has therefore a venturi nozzle 16 generating a suction pressure in the suction hose 15 by the pressurized air, a pre-filter and a post-filter to clean the exhaust gas. Moreover, the suction device 13 can have an integrated weighing machine for weighing the first replacement container 14. Thereby, it is possible to detect the powder mass which is presently inside the replacement container 14.

The remaining powder 3a sucked by the suction pressure is discharged in the first replacement container 14 by a first hose 17. The first hose 17 can be connected with its lower end to an upper opening of the first replacement container 14 by a quick coupler 18, and it provides for a dust- or airtight connection of the suction device 13 to the first replacement container 14. Such quick couplers 18 can be camlock-couplers or other lever arm couplers.

The upper end of the first hose 17 is fixed to an outlet of the venturi nozzle 16 by a hose clamp (not shown).

FIG. 3 shows a sieving device 19 which is separately provided from the building device. Similar to the suction device 13, the sieving device 19 is placed in a mobile creeper and has an accommodation area for a second replacement container 20. The second replacement container 20 is replaceable arranged in the accommodation area of the sieving device 19. Preferably, the second replacement container 20 is constructed in the same way as the first replacement container 14. The sieving device 19 further has a sieve 21 such as a vibrating wire sieve. The sieve 21 is inserted in the sieving device 19 like a sieve insert into a sieve casing 22. The sieve casing 22 consists of two casing shells which can be separated from each other in order to open the sieve casing 22. Preferably, the sieving device 19 further has an additional ultrasound generator (not shown) for preventing clogging of the sieve 21, an oversize particle outlet (not shown) for discharging rough powder components, and an additional metering device for controlling the powder amount which is supplied to the sieve.

The sieve 21 has a port 23 for a second hose (not shown) at an inlet thereof. The second hose is connected to the port 23 of the sieve 21 at one end by means of a host clamp in a dust- or airtight manner. The other end of the second hose is connectible to the upper opening of the first replacement container 14 by a quick coupler. The quick coupler is similar to the quick coupler 18 which is used for the suction device 13. Moreover, the sieving device 19 can comprise an integrated weighing machine for weighing the second replacement container 14. Thereby, it is possible to detect the powder mass which is presently in the replacement container 14.

A third hose 24 is connected at one end to an exit of the sieve 21 by a hose clamp (not shown). The other end of the third hose 24 is connectible to an upper opening of the second replacement container 20 by a quick coupler 25.

The sieving device 19 sieves the remaining powder 3a supplied from the first replacement container 14, and it supplies the same to the second replacement container 20 which is separately provided from the building device.

FIG. 4 shows a supplying device 26, which is separately provided from the building device, for supplying the sieved remaining powder 3a to the building device. The supplying device 26 has accommodations for at least one replacement container 14, 20 in an upper portion, wherein the second replacement container 20, which is shown here, is arranged upside down so that the openings 27 thereof are directed downwards. The powder 3a in the second replacement container 20 can be discharged by gravity through the opening 27. The second replacement container 20 in turn has a closure (not shown) so that the powder 3a therein can not be accidentally discharged. Such a closure can be formed as a rotatable shutter. Preferably, the closure is controlled by the building device. Preferably, a metering device at the supplying device 26 or at the replacement containers 14, 20 is additionally provided, which is preferably controlled by the building device. Additionally, the supplying device 26 can comprise an exchangeable nozzle to be connected with the opening of the second replacement container 20. Moreover, the supplying device 26 can comprise an integrated weighing machine for weighing the second replacement container 20. Thereby, it is possible to detect the powder mass which is presently inside the replacement container 20.

The described hoses 15, 17, 24 are exchangeable, since they are connected to the suction device 13, the sieving device 19 or the supplying device 26 by hose clamps in a dust- or airtight manner. In place of the hose clamps, quick couplers can be used. The dust- or airtight connection of the hoses 17, 24 to the replacement containers 14, 25 is also realized by quick couplers 18, 25.

Preferably, the supplying device 26 is constructed such that it can be moved over the sieving device 19. In this manner, the first replacement container 14 can be placed upside down in the supplying device 26 by a later described transport device so that the first replacement container 14 is directly located over the sieve 21 of the sieving device 19.

FIG. 5 shows the transport device 28 for transporting the first and/or the second replacement containers 14, 20. The transport device 28 is formed as a roll lifting cart having a fork with two support arms 29 and being adjustable in height. The fork is moved up and down by a hand wheel (not shown) via a chain drive, for instance. Onto both support arms 29, two adapter pieces having coaxially arranged recesses 30 are placed. Alternatively, the recesses can also be directly machined in the support arms 29. The recesses 30 correspond to axes 31 which are laterally attached at the first and second replacement containers 14, 20. When the first replacement container 14 and the second replacement container 20 are arranged in the respective accommodation portions of the suction device 13 and the sieving device 19, the recesses 30 of the support arms 29 can be moved below the corresponding axes 31 of the replacement containers 14, 20. By the hand wheel, the support arms 29 can be lifted up so that the recesses 30 of the support arms 29 engage with the corresponding axes 31 of the replacement containers 14, 20, and the replacement containers 14, 20 can be lifted up. After having released the replacement containers 14, 20 by releasing the quick couplers 18, 25 from the hoses 17, 24, the replacement containers 14, 20 can be transported to the next station by the transport device 28.

The same transport device 28 can also be used for transporting the substrate plate or one of the clamping systems, as it is shown in FIG. 6. For this purpose, an adapter in the shape of an adapter plate 32 is placed onto the support arms 29. The adapter plate 32 can be placed onto the support arms 29 in different orientations so that accommodation of different substrate plates and clamping systems is enabled. The left side of FIG. 6 shows a first position of the adapter plate 32 to accommodate a standard substrate plate, and the right side of FIG. 6 shows a second position of the adapter plate 32 to accommodate the clamping system, wherein it is rotated around the vertical axis by 180°.

It is obvious that the support arms 29 of the transport device 28 can comprise additional adapters or coaxially arranged recesses which are adapted to arbitrary replacement containers and substrate plates having different sizes and shapes.

The system for recycling remaining powder 3a from an equipment for generatively manufacturing three-dimensional objects 3 can further comprise a device for mixing the sieved or non-sieved remaining powder 3a with another powder. In particular, the other powder can be fresh powder which has not been used yet. The device for mixing can further comprise a device for homogenising the powder mixture or for homogenising remaining powder or fresh powder.

The system for recycling remaining powder 3a from an equipment for generatively manufacturing three-dimensional objects 3 has, in addition to the sieving device or the mixing device, a further device for modifying a characteristic of the powder resulting from that.

The further device can have a device for removing particles with less than a defined grain size. In particular, the removal is then performed by separating.

The further device can be a device for selectively modifying the chemical composition of the remaining powder 3a or the resulting powder. Preferably, the selective modification of the chemical composition is then made by reduction of oxides.

The further device can be a device for selectively modifying the composition or a characteristic of the atmosphere around the particle of the remaining powder 3a or the resulting powder. Preferably, the selective modification is then performed by modifying a main gas in the atmosphere and/or by modifying a degree of moisture in the atmosphere and/or the pressure of the atmosphere.

The further device can be a device for removing contaminations from the remaining powder 3a or the resulting powder aside from the sieving device. Preferably, the removal of contamination is performed by using a physical or chemical characteristic of the remaining powder 3a or the resulting powder in order to separate it from the contaminations. More preferred, the physical or chemical characteristic of the remaining powder 3a or the resulting powder includes the geometrical shape, the density and/or the specific mass, the electrical conductivity, the magnetizability or the solubility in a defined fluid medium.

Preferably, the characteristic of the resulted powder modified by the preparing step is measured before or after the preparing step. More preferred, the measured characteristic is recorded. More preferred, the measured characteristic is electronically stored as a data set.

Preferably, the measured characteristic is allocated to the resulting powder. More preferred, the measured characteristic is stored on or in connection with a powder container, or the measured characteristic is transferred to a control of the equipment when recycling the resulting powder for manufacturing three-dimensional objects.

Preferably, the measured characteristic is allocated to an object 3 being generatively manufactured by use of the resulting powder.

Thus, the further device can be a device for measuring a characteristic of the remaining powder 3a, the resulting powder, the prepared powder or the fresh powder. Such a characteristic of the remaining powder 3a, the resulting powder, the prepared powder or the fresh powder can particularly be a grain size distribution, a chemical composition, a flowability or a degree of moisture. The measured characteristic of the remaining powder 3a, the resulting powder, the prepared powder or the fresh powder can be stored and recorded in a storage.

Thus, the further device can also be a device which labels the first or second storage containers 14, 20 by the characteristic of the remaining powder 3a, the resulting powder, the prepared powder or the fresh powder. In particular, this can be realized by attaching a bar code or a RFID-chip (Radio Frequency Identification) at the first or second storage containers 14, 20. In the bar code and in the RFID-chip, the characteristic of the remaining powder 3a, the resulting powder, the prepared powder or the fresh powder is stored.

Thus, the further device can also be a device for removing fine particles from the remaining powder 3a, the resulting powder, the prepared powder or the fresh powder by separating or by sieving. Preferably, this can be performed by air separation, that means pneumatically or by means of a cyclone.

Thus, the further device can also be a device for preparing the remaining powder 3a, the resulting powder, the prepared powder or the fresh powder. In particular, the chemical preparation can be performed by subjecting the powder to a reductive gas.

Thus, the further device can also be a device for drying or moistening the remaining powder 3a, the resulting powder, the prepared powder or the fresh powder in order to modify the degree of moisture thereof.

Thus, the further device can also be a device for removing contaminations from the remaining powder 3a, the resulting powder, the prepared powder or the fresh powder. Such contaminations can be abrasive wear of an application blade of the applicator 5 or abrasive wear of a brush (not shown).

Thus, the further device can also be a device for transferring the characteristic of the remaining powder 3a, the resulting powder, the prepared powder or the fresh powder, which is stored in the bar code or the RFID-chip, for example, to the building device. The building device in turn can comprise a device for modifying a parameter of manufacturing the three-dimensional object 3 in accordance to the measured characteristic of the remaining powder 3a, the resulting powder, the prepared powder or the fresh powder. The building device can output a corresponding notice or alert to the user. The device for modifying the parameters can alternatively be realized by the control unit 11 and the associated software. Such a parameter can be a laser power, a laser scanning speed, a process temperature, a process gas composition or a pulsed or continuous operation of the laser. Such characteristics are allocated to the object 3 accordingly, after having them transferred to the building device.

The operation of the system for recycling remaining powder from an equipment for generatively manufacturing three-dimensional objects 3 is as follows:

After finishing the three-dimensional object 3 in the building space of the building device, the door of the process chamber is opened. The first replacement container 14 has been placed into the accommodation of the suction device 13, and the upper opening thereof has been connected to the suction device 13 by the quick coupler 18 in a dust- or airtight manner. The non-solidified remaining powder 3a is sucked by the flexible suction hose 15 of the suction device 13 from the building device in the first replacement container 14 which is placed in the suction device 13. Thereafter, the transport device 28 is moved to the suction device 13 or vice versa such that the recesses 30 of the support arms 29 lie below the corresponding axes 31 of the first replacement container 14. The support arms 29 are lifted by rotating the hand wheel so that the recesses 30 of the support arms 29 engage with the corresponding axes 31 of the first replacement container 14, and the first replacement container 14 is lifted up. After having separated the upper opening of the first replacement container 14 from the first hose 17 by releasing the quick coupler 18, the first replacement container 14 is transported to the sieving device 19 by the transport device 28.

At the sieving device 19, the upper opening of the first replacement container 14 is connected in a dust- or airtight manner to the second hose (not shown) by the quick coupler (not shown). The second replacement container has already been connected in a dust- or airtight manner to the third hose 24 by the quick coupler 25.

The remaining powder 3a is supplied via the second hose to the sieving device 19, which sieves the same by the sieve 21. The metering device prevents that too much powder reaches the sieve. The additionally provided ultrasound generator prevents the sieve 21 from being clogged at the same time. After having passed the sieve 21, the remaining powder 3a falls through the third hose 24 into the second replacement container 20.

Thereafter, the upper opening of the second replacement container 20 is separated from the third hose 24 by releasing the quick coupler 25, and the second replacement container 20 is transported to the supplying device 26 by the transport device 28 in a similar manner as described for the first replacement container 14. Preferably, mixing of the powder with another powder and/or the preparing step of modifying a characteristic of the resulting powder is performed now. The second replacement container 20, when resting on the support arms 29, is rotated upside down for example by a tilting device (not shown) and moved upwards so that it can be arranged in an upper portion of the supplying device 26. The closure of the second replacement container 20 is closed at the same time, so that the powder does not accidentally leak out. The opening of the second replacement container 20 can now be connected to a further hose so that the remaining powder 3a, which is located therein, can be supplied back to the building device. The supply of the remaining powder 3a from the second replacement container 20 to the building device can be realized by the gravity of the powder or pneumatically. Preferably, the further hose comprises at one end a slider or a closure which can separate the hose from the powder in the building device in a dust- or airtight manner.

In addition to sieving the remaining powder 3a or to mixing the remaining powder 3a with another powder, a further preparing step for modifying a characteristic of the powder resulting from that is performed.

The further preparing step can be a step of removing particles below a defined grain size. Preferably, the removal is then performed by separation.

The further preparing step can be a step of selectively modifying the chemical composition of the remaining powder 3a or the resulting powder. Preferably, the selective modification of the chemical composition is then performed by reduction of oxides.

The further preparation step can be a step of selectively modifying the composition of the atmosphere around the particles of the remaining powder 3a or the resulting powder. Preferably, the selective modification is then performed by modifying a main gas in the atmosphere and/or by modifying a degree of moisture in the atmosphere.

The further preparing step can be a step of removing contaminations from the remaining powder 3a or the resulting powder aside from the sieving. Preferably, the removal of contaminations is performed by using a physical or chemical characteristic of the remaining powder 3a or the resulting powder in order to separate it from the contaminations. More preferred, the physical or chemical characteristic of the remaining powder 3a or the resulting powder includes the geometrical shape, the density and/or the specific mass, the electrical conductivity, the magnetizability or the solubility in a defined fluid medium.

Preferably, the characteristic is measured before or after the preparing step. More preferred, the measured characteristic is recorded. More preferred, the measured characteristic is electronically stored as a data set.

Preferably, the measured characteristic is allocated to the resulting powder. More preferred, the measured characteristic is stored on or in connection with a powder container, or the measured characteristic is transferred to a control of the equipment during recycling the resulting powder for manufacturing three-dimensional objects.

Preferably, the measured characteristic is allocated to an object 3 being generatively manufactured by use of the resulting powder.

At any time, in particular before transporting the second replacement container 20 to the supplying device 26 and after filling the remaining powder 3a into the second replacement container 20, these steps can be performed for a quality management. Thus, such steps particularly include a step of measuring a characteristic of the remaining powder 3a, the resulting powder, the prepared powder or the fresh powder, wherein the characteristic is particular a grain shape, a grain shape distribution, a chemical composition, a flowability or a degree of moisture of the sieved remaining powder 3a; a step of labelling a replacement container 14, 20 with the characteristic of the remaining powder 3a, the resulting powder, the prepared powder or the fresh powder, in particular by attaching a bar code or a RFID-chip, in which the characteristic is stored, on the replacement container 14, 20; a step of removing fine particles from the remaining powder 3a, the resulting powder, the prepared powder or the fresh powder by separating; a step of preparing the remaining powder 3a, the resulting powder, the prepared powder or the fresh powder, in particular by chemical preparation by means of reduction of oxides; a step of removing contaminations from the remaining powder 3a, the resulting powder, the prepared powder or the fresh powder, which can be performed magnetically, electrostatically or elsewhere; a step of mixing the remaining powder 3a, the resulting powder, the prepared powder or the fresh powder with another powder; and a step of homogenising the resulting powder mixture. The method or individual steps of the method can be performed in an inert gas atmosphere which is particularly an advantage for high reactive powder materials. Preferably, the suction device 13, the sieving device 19 and/or the supplying device 26 have then a port for supplying or discharging the inert gas.

The characteristic of the remaining powder 3a, the resulting powder, the prepared powder or the fresh powder, which is stored in the bar code or the RFID-chip, for example, can be transferred to the building device. Furthermore, the characteristic, which is transferred to the building device, can be allocated to the object 3. The control unit 11 can modify a parameter of manufacturing the three-dimensional objects 3 in accordance to the measured characteristic of the remaining powder 3a, the resulting powder, the prepared powder or the fresh powder.

The present invention offers the following advantages:

The suction- and sieving devices 13, 19 having the replacement containers 14, 20 and being separately provided from the building device enable a quality management of the remaining powder 3a, the resulting powder, the prepared powder or the fresh powder, which can be adapted to the customer's desire in a cost-effective and flexible manner.

The exchangeable hoses 15, 17, 24 can be easily exchanged or cleaned. Thus, it is possibly to use the same sieving device 19 and the same suction device 13 for different building devices, which in turn use different powder materials, after exchanging or after cleaning the hoses 15, 17, 24.

The exchangeable nozzle of the supplying device 26 enables different functions such as draining a bleeder container, removal of powder from work pieces, conveying separate powder containers, etc.

The replacement container enables classification and documentation of the powder for the quality management. Furthermore, the transport and the mixing and homogenising of different powders are simplified.

The scope or protection is not restricted by the described embodiment, but it embraces further modifications and changes, provided that these fall within the scope as defined by the enclosed claims.

Preferably, the first replacement container 14 is constructed in the same way as the second replacement container 20. However, this is not essential for the invention' so that the replacement containers 14, 20 can also be different from each other.

In place of the laser 7, an energetic particle radiation such as an electron beam can be used. It is not necessary that the powder 3a is laser sintered, but it can also be molten by laser.

The components as described in the system can be arbitrarily combined; for example, the suction device can be integrated in the sieving device. The sieving device can also be integrated in the supplying device.

The removal of the powder from the building device is performed by the suction device in the embodiment. Alternatively, the removal of the powder can be performed by blowing out and collecting the powder or by draining the powder by means of its gravity force.

Instead of pressurized air, the suction device can also be operated by vacuum or electrically.

The preparation of the powder can not only be applied to sieved remaining powder 3a, but also to fresh powder or to non-sieved powder.

The removal of fine particles from the sieved remaining powder 3a can be performed by a double sieve; rough parts remain above the double sieve, and fine parts are deposited below the double sieve. The sieved remaining powder 3a is withdrawn there between.

The individual steps can be optionally performed in an inert gas atmosphere, that means, with protective gas.

The building device is not restricted to the laser sintering machine, but it can be any building device which applies a layer-wise generating method such as 3D-printing.

A method of recycling of remaining powder 3a from an equipment for generatively manufacturing three-dimensional objects 3 is disclosed, wherein in addition to sieving the remaining powder 3a or mixing the remaining powder 3a with another powder, a further preparing step of modifying a characteristic of the resulting powder is performed. The further preparing step includes removing contaminations from the remaining powder 3a or the resulting powder by another step aside from sieving, wherein the removing of contaminations is performed by using a physical or chemical characteristic of the remaining powder 3a or the resulting powder, in order to separate these from the contaminations. Preferably, the physical or chemical characteristic includes the geometrical form, the density and/or the specific mass, the electrical conductivity, the magnetizability or the solubility in a defined fluid medium.

A System for recycling of remaining powder from an equipment for generatively manufacturing three-dimensional objects 3 is disclosed, which performs any one of the above-mentioned methods. The System further comprises a building device, which layer-wise applies a powdery material onto a support or a previously applied layer, and solidifies the powdery material by energetic radiation at locations corresponding to the object 3, a suction device 13 with a first replacement container 14, in which the suction device 13 suctions non-solidified remaining powder 3a from the building device, the suction device 13 is separately provided from the building device. Preferably, the system further comprises a sieving device 19, which is separately provided from the building device and sieves the remaining powder 3a, which is supplied from the first replacement container 14, and supplies the same to a second replacement container 20, which is separately provided from the building device. Preferably, the suction device 13 comprises a pressurized air sucker having a venturi nozzle 16 and a pre-filter. Preferably, the sieving device 19 comprises a vibration sieve 21 and an additional ultrasound generator to prevent the sieve from being clogged. Preferably, the system further comprises a supplying device 26, which is separately provided from the building device, for supplying the remaining powder 3a, the resulting powder, the prepared powder or fresh powder to the building device. Preferably, the supplying device 26 comprises an exchangeable nozzle. Preferably, the suction device 13, the sieving device 19 and/or the supplying device 26 comprise an integrated weighing machine. Preferably, the system further comprises at least one exchangeable hose 17, 24, which connects at least one replacement container 14, 20 to the suction device 13, the sieving device 19 or the supplying device 26, a quick coupler 18, 25 to connect the at least one replacement container 20 to the hose 17, 24 in a dust- or airtight manner, and a hose clamp or a quick coupler to connect the at least one hose 17, 24 to the suction device 13, the sieving device 19 or the supplying device 26 in a dust- or airtight manner. Preferably, the system further comprises a transport device 28 for transporting the first and/or the second replacement container 20. Preferably, the transport device 28 comprises at least one adapter 30, 32, which is suitable to transport the first and/or the second replacement container 14, 20 as well as a substrate plate to be attached in the building device or a clamping system to be attached in the building device, on which the three-dimensional object 3 is to be built. Preferably, the system further comprises a device for removing fine particles from the remaining powder 3a, the resulting powder, the prepared powder or the fresh powder by separating. Preferably, the system further comprises a device for preparing the remaining powder 3a, the resulting powder, the prepared powder or the fresh powder, in particular by chemically preparing by means of reduction of oxides. Preferably, the system further comprises a device for removing contaminations from the remaining powder 3a, the resulting powder, the prepared powder or the fresh powder. Preferably, the system further comprises a device for mixing the remaining powder 3a, the resulting powder, the prepared powder or the fresh powder with another powder.

1-16. (canceled)

17. A method of recycling of remaining powder from an equipment for generatively manufacturing three-dimensional objects, the method comprising sieving the remaining powder or mixing the remaining powder with another powder, and modifying a characteristic of the resulting powder.

18. The method according to claim 17, further comprising removing particles with less than a defined grain size.

19. The method according to claim 17, further comprising separating particles with less than a defined grain size.

20. The method according to claim 17, further comprising selectively modifying the chemical composition of the remaining powder or the resulting powder.

21. The method according to claim 20, wherein the step of selectively modifying of the chemical composition includes reducing oxides.

22. The method according to claim 17, further comprising selectively modifying the composition of the atmosphere around the particles of the remaining powder or the resulting powder.

23. The method according to claim 17, wherein the step of selectively modifying comprises modifying a main gas or a degree of moisture in the atmosphere.

24. The method according to claim 17, further comprising removing contaminations from the remaining powder or the resulting powder without sieving.

25. The method according to claim 17, further comprising measuring the characteristic before and/or after the modifying step.

26. The method according to claim 25, further comprising recording the measured characteristic.

27. The method according to claim 25, further comprising electronically storing the measured characteristic as data set.

28. The method according to claim 25, further comprising allocating the measured characteristic to the resulting powder

29. The method according to claim 25, further comprising storing the measured characteristic in connection with a powder container.

30. The method according to claim 28, further comprising transferring the measured characteristic to a controller of the equipment when recycling the resulting powder for manufacturing three-dimensional objects.

31. The method according to claim 28, further comprising allocating the measured characteristic to an object, which is generatively manufactured by use of the resulting powder.

32. A system for recycling of remaining powder from an equipment for generatively manufacturing three-dimensional objects, which is structured and arranged to perform the method according to claim 17.

33. The system according to claim 32, comprising a device for measuring a characteristic of the remaining powder, the resulting powder, the prepared powder or fresh powder.

34. The system according to claim 32, comprising a device for measuring a characteristic selected from the group consisting of a grain size distribution, a chemical composition, and a flowability or a degree of moisture of the sieved remaining powder (3a), the remaining powder (3a), the resulting powder, the prepared powder or the fresh powder.

35. The system according to claim 33, further comprising:
a device for labeling a powder container by the characteristic of the remaining powder, the resulting powder, the prepared powder or the fresh powder.

36. The system according to claim 33, wherein the labeling device is constructed and arranged to attach a bar code or a RFID-chip, in which the characteristic is stored, on a powder container.

37. The system according to claim 33, further comprising:
a device for transferring the characteristic of the remaining powder, the resulting powder, the prepared powder or the fresh powder, which is stored in the label, to a building device, and
a device for modifying a parameter of manufacturing the three-dimensional object in accordance to the measured characteristic of the remaining powder, the resulting powder, the prepared powder or the fresh powder.

38. The system according to claim 34, further comprising:
a device for transferring the characteristic of the remaining powder, the resulting powder, the prepared powder or the fresh powder, which is stored in the label, to a building device, and
a device for modifying a parameter of manufacturing the three-dimensional object in accordance to the measured characteristic of the remaining powder, the resulting powder, the prepared powder or the fresh powder.

39. The system according to claim 32, further comprising a device for homogenizing the resulting powder mixture.
